(19) United States
(12) Patent Application Publication
(10) Pub. No.: US 2008/0315764 A1
(43) Pub. Date: Dec. 25, 2008

(54) Plasma display panel

(76) Inventor: Jung-Suk Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/068,611

(22) Filed: Feb. 8, 2008

(30) Foreign Application Priority Data
Jun. 22, 2007 (KR) 10-2007-0061569

(51) Int. Cl. H01J 17/49

(52) U.S. Cl. 313/582

(57) ABSTRACT

A PDP includes a first substrate and a second substrate positioned to face each other, a barrier rib arranged between the first and second substrates to define a discharge cell, and discharge electrode having address electrodes and display electrodes. The address electrodes may extend along a first direction and the display electrodes may extend along a second direction intersecting the first direction. The display electrodes may include a first electrode and a second electrode extending in the second direction, such that the first and second electrodes may correspond to the barrier rib. The barrier rib may include a wide width portion having a first width W1 formed at a side of the first substrate and a narrow width portion having a second width W2 formed at a side of the second substrate. The second width W2 may be narrower than the first width W1.

### BACKGROUND OF THE INVENTION

1. Field of the Invention

Example embodiments relate to a plasma display panel (PDP) and, more particularly, to a PDP maintaining a low reflective luminance.

2. Description of the Related Art

PDP display devices typically realize images using visible light, e.g., red, green and blue light. The visible light may be generated when photoluminescent materials, e.g., phosphors, stabilize after ultraviolet (UV) light, e.g., UV rays, excite the photoluminescent materials. UV light may be radiated by plasma that may be obtained via gas discharge.

PDPs may further be classified as an alternating current (AC) type PDP or a direct current (DC) type PDP according to a type of driving voltage employed therein. For example, discharge electrodes of the PDP may include address electrodes arranged on a rear substrate and sustain and scan electrodes arranged on a front substrate intersecting the address electrodes. The discharge electrodes may further include a transparent electrode to generate a surface discharge in a discharge cell and a bus electrode to apply a voltage to the transparent electrode. The transparent electrode and the bus electrode may each be made from an opaque material, e.g., a black color.

Since the transparent and bus electrodes may be made from opaque material, a reflection luminance of external light may be diminished and the visible light emitted from the discharge cell may be blocked.

### SUMMARY OF THE INVENTION

Example embodiments are therefore directed to a PDP, which substantially overcome one or more of the problems due to the limitations and disadvantages of the related art.

It is therefore a feature of example embodiments to provide a PDP having a low reflective luminance by optimizing a ratio of a width of a bus electrode with respect to a width of a barrier rib.

Another feature of example embodiments may provide a PDP with maximized efficiency by preventing and/or reducing deterioration of luminance.

At least one of the above and other features of example embodiments may provide a PDP, including a first substrate and a second substrate positioned to face each other, a barrier rib arranged between the first and second substrates to define discharge cell, a photoluminescent layer formed in the discharge cell, and discharge electrodes including address electrodes and display electrodes. The address electrodes may extend along a first direction and the display electrodes may extend along a second direction intersecting the first direction. The display electrodes may include a first electrode and a second electrode extending in the second direction, the first and second electrodes may correspond to the barrier rib. The barrier rib may include a wide width portion having a first width W1 formed at a side of the first substrate and a narrow width portion having a second width W2 formed at a side of the second substrate side. The second width W2 may be narrower than the first width W1.

The first and second electrodes may be bus electrodes. The bus electrodes may include a width W3 that may be narrower than the first width and wider than the second width of the barrier rib. A ratio of the second width to the first width (W2/W1) may be approximately 0.20 to 0.45. The first width W1 may be approximately 100 μm to 160 μm and the second width W2 may be approximately 35 μm to 45 μm. The first width W1 may be approximately 100 μm to 120 μm and the second width W2 may be approximately 35 μm to 40 μm. The first width W1 may be approximately 60 μm to 100 μm and the second width W2 may be approximately 40 μm to 45 μm. The third width W3 of the bus electrodes may be approximately one to two times wider than the second width W2.

A surface of the barrier rib may be sloped extending from the wide width portion of the barrier rib to the narrow width portion of the barrier rib. The barrier rib may include first barrier rib members extending in the first direction and formed at the discharge cell interval along the second direction and second barrier rib members extending in the second direction between the first barrier rib members, and formed at the discharge cell interval along the first direction. The bus electrode may be formed at the second substrate corresponding to the second barrier rib members. The second barrier rib members may include a third barrier rib member and a fourth barrier rib member. The third barrier rib member and the fourth barrier rib member may be separated between consecutive discharge cells in the first direction to form an exhaust path. The PDP may include a bridge barrier rib connecting the third barrier rib member and the fourth barrier rib member. The bridge barrier rib may be disposed between the third barrier rib member and the fourth barrier rib member in the first direction. The bus electrode may be formed on the second substrate corresponding to the third barrier rib member and the fourth barrier rib member.

### BRIEF DESCRIPTION OF THE DRAWINGS

The above and other features and advantages of example embodiments will become more apparent to those of ordinary skill in the art by describing in detail example embodiments thereof with reference to the attached drawings, in which:

FIG. 1 illustrates an exploded perspective view of a PDP according to an example embodiment;

FIG. 2 illustrates a cross-sectional view taken along the line II-II of FIG. 1; and

FIG. 3 illustrates a top plan view of an exemplary PDP of FIG. 1.

### DETAILED DESCRIPTION OF THE INVENTION

Korean Patent Application No. 10-2007-0061569 filed on Jun. 22, 2007, in the Korean Intellectual Property Office, and entitled “Plasma Display Panel,” is incorporated by reference herein in its entirety.

Example embodiments will now be described more fully hereinafter with reference to the accompanying drawings; however, example embodiments may be embodied in different forms and should not be construed as limited to the embodiments set fourth herein. Rather, these example embodiments are provided so that this disclosure will be thorough and complete, and will fully convey the scope of the invention to those skilled in the art.

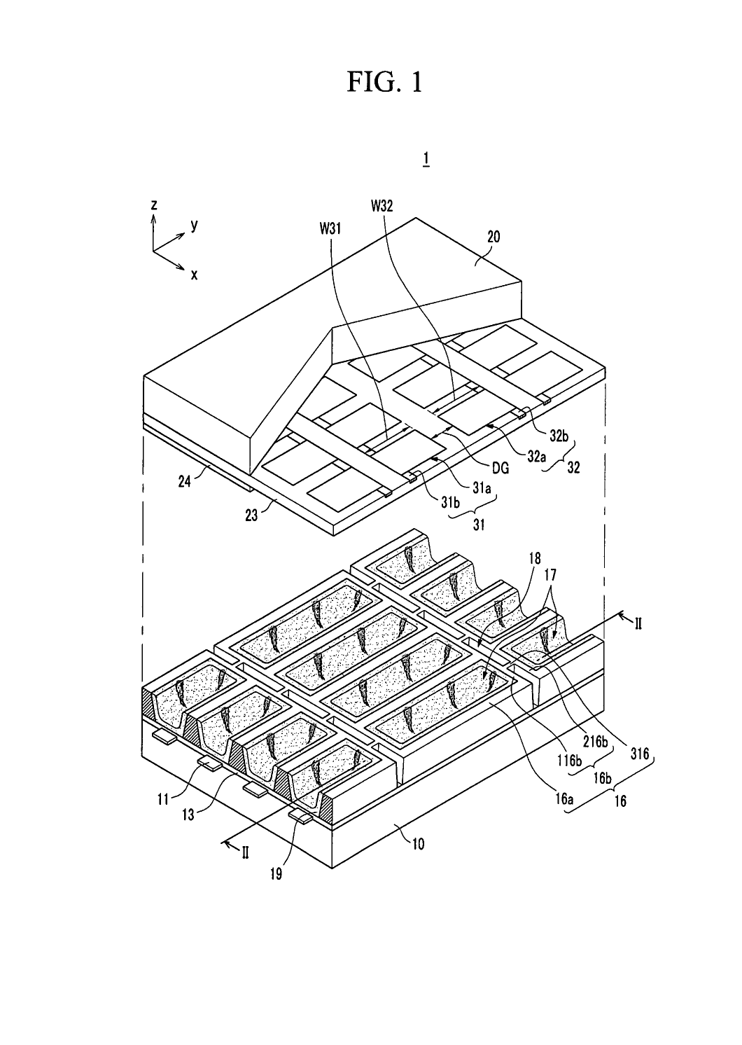

Referring to FIG. 1, a PDP 1 may include a first substrate (hereinafter referred to as “rear substrate”) 10 and a second substrate (hereinafter referred to as “front substrate”) 20 that may be superposed to each other. The PDP 1 may further include a barrier rib 16 formed between the rear and front substrates 10 and 20 to define discharge cells 17. The rear and front substrates 10 and 20 may be disposed in parallel and may face each other. The rear and front substrates 10 and 20 may be formed of a transparent substrate, e.g., a soda lime glass, a semi-transmissible substrate, a reflective substrate, or a colored substrate. A frit glass (not shown) may be applied to peripheral areas of inner surfaces of the rear and front substrates 10 and 20 to be connected therebetween, in order to form a sealed space between the rear and front substrates 10 and 20.

The barrier rib 16 may be formed between the rear substrate 10 and the front substrate 20 with a predetermined height to partition a plurality of discharge cells 17. The discharge cells 17 may be filled with a discharge gas, e.g., neon (Ne), xenon (Xe), helium (He) or a combination thereof, so as to generate UV light, e.g., vacuum ultraviolet (VUV) light, via gas discharging. A photoluminescent layer 19, e.g., a phosphor, may be formed in the discharge cells 17 to absorb the UV light and emit visible light. In other words, the photoluminescent layer 19 may be disposed on inner surfaces of the discharge cells 17, so that voltage applied to the discharge gas may trigger UV light generation, followed by emission of visible light by the photoluminescent layer 19. The photoluminescent layer 19 may be formed on any portion of the inner surface of the discharge cells 17, e.g., upper surface of a dielectric layer 13 and/or side surfaces of the barrier ribs 16.

The photoluminescent layer 19 may be formed by a dispensing method, i.e., dispensing phosphor pastes with a dispenser (not shown) moving along a first direction (i.e., y-axis direction) and then drying and firing the dispensed phosphor pastes. Other methods may be employed to form the photoluminescent layer 19. The photoluminescent layer 19 may be formed with the same color phosphor at the discharge cells 17. Further, the photoluminescent layers 19 may include a phosphor layer emitting red light, e.g., (Y,Gd)BO₃;Eu⁺³, a phosphor layer emitting green light, e.g., Zn₂SiO₄:Mn²⁺ and a phosphor layer emitting blue light, e.g., BaMgAl₁₀O₁₇:Eu²⁺.

The PDP 1 may further include an address electrode 11, a first electrode (hereinafter referred to as “sustain electrode”) 31 and a second electrode (hereinafter referred to as “scan electrode”) 32, corresponding to the respective discharge cells 17 between the rear and front substrates 10 and 20. The address electrode 11 may be formed extending along the first direction (i.e., y-axis direction) on the inner surface of the rear substrate 10 to sequentially correspond to discharge cells 17 neighboring each other. The address electrodes 11 may also be disposed parallel with each other to correspond to the discharge cells 17 neighboring each other in a second direction (i.e., x-axis direction).

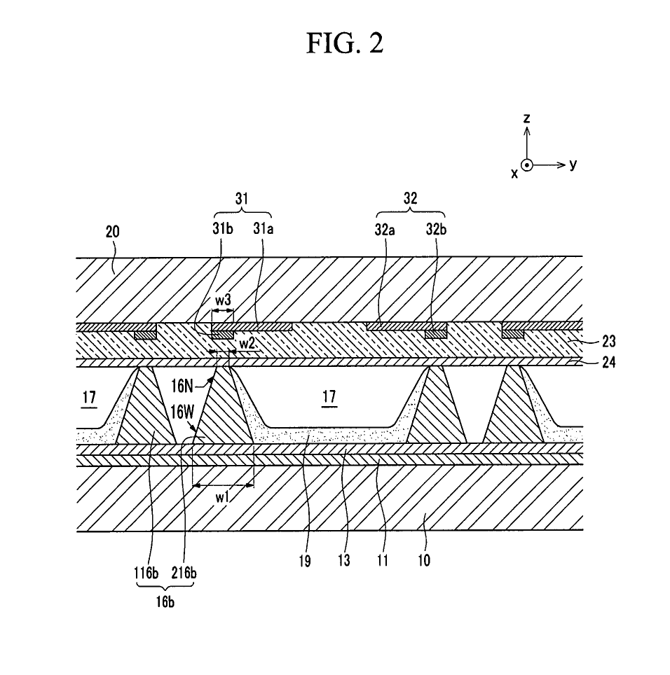

Referring to FIG. 2, a first dielectric layer 13 may be formed on the rear substrate 10, and a protective layer 24 and a second dielectric layer 23 may be formed on the front substrate 20. The barrier ribs 16 may be disposed between the rear substrate 10 and the front substrate 20 and, more particularly, between the first dielectric layer 13 and the protective layer 24.

The first dielectric layer 13 may be formed on the inner surface of the rear substrate 10 to cover the address electrodes 11. During discharging, the first dielectric layer 13 may reduce positive ions or electrons from directly colliding with the address electrodes 11, which may damage the address electrodes 11. The first dielectric layer 13 may further accumulate wall charges during a discharge. The first dielectric layer 13 may be formed of a transparent dielectric material, e.g., a mixture of PbO—B₂O₃—SiO₂.

Further, because the address electrodes 11 may be disposed on the rear substrate 10, the address electrodes 11 may not obstruct a forward path of visible light. The address electrodes 11 may be made of nontransparent materials and highly conductive metal, e.g., silver (Ag).

The barrier ribs 16 may be disposed on the first dielectric layer 13 on the rear substrate 10, defining the discharge cells 17. The barrier ribs 16 may include first barrier rib members 16a and second barrier rib members 16b, partitioning the discharge cells 17 in a matrix. The first barrier rib members 16a may extend along the first direction (i.e., y-axis direction) and may be arranged apart from each other by a distance therebetween along the second direction (i.e., x-axis direction). The second barrier rib members 16b may extend along the second direction (i.e., x-axis direction), and may be arranged apart from each other by a distance therebetween along the first direction (i.e., y-axis direction).

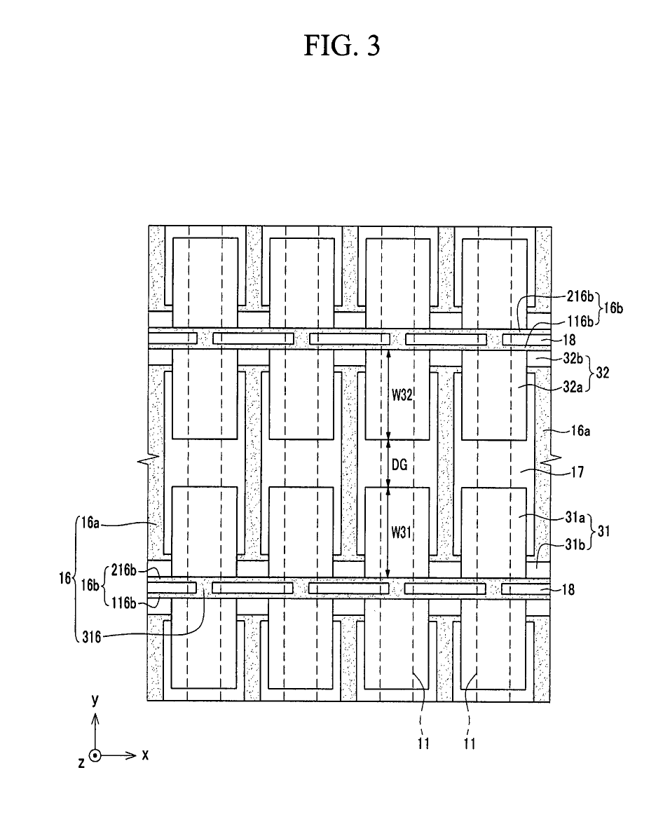

Referring to FIG. 3, the sustain electrode 31 and scan electrode 32 may be formed in the second direction (i.e., x-axis direction) intersecting the address electrode 11. The sustain electrode 31 and the scan electrode 32 may be formed on the inner surface of the front substrate 20, so as to generate the gas discharge in the discharge cells 17.

The sustain electrode 31 and scan electrode 32 may respectively include transparent electrodes 31a and 32a to generate discharge and bus electrodes 31b and 32b to apply voltage signals to the transparent electrodes 31a and 32a. The transparent electrodes 31a and 32a may generate a surface discharge within the discharge cell 17, and may be made of a transparent conductive material, e.g., indium tin oxide (ITO), for ensuring an adequate aperture ratio of the discharge cell 17. The bus electrodes 31b and 32b may form a pattern and may be made of a highly conductive metallic material, e.g., a silver (Ag) paste or a chromium-cobalt alloy (Cr—Co—Cr) with high electrical conductivity, to compensate for the high electrical resistance of the transparent electrodes 31a and 32a. The bus electrodes 31b and 32b may be opaque, e.g., a black color, so as to reduce reflection luminance of external light.

The transparent electrodes 31a and 32a may extend from edges of the discharge cells 17 toward a center along the first direction (i.e., y-axis direction). The transparent electrodes 31a and 32a may have widths W31 and W32, respectively, and may form a discharge gap DG in a center of each of the discharge cells 17.

The bus electrodes 31b and 32b may be disposed on the transparent electrodes 31a and 32a, respectively, and may be formed extending in the second direction (i.e., x-axis direction) outside of the discharge cell 17. When a voltage signal is applied to the bus electrodes 31b and 32b, the voltage signal may be transferred to the transparent electrodes 31a and 32a connected to the bus electrodes 31b and 32b, respectively.

Further, an opaque protrusion electrode (not shown), protruding from the bus electrodes 31b and 32b to the inside of the discharge cell 17, may be formed. The opaque protrusion electrode may be made of the same material as the bus electrodes 31b and 32b. The protrusion electrode may act as the transparent electrodes 31a and 32a, which may form the discharge gap DG.

Referring back to FIGS. 1 and 2, the sustain and scan electrodes 31 and 32 may intersect the address electrodes 11 and may face each other in the discharge cell 17. The second dielectric layer 23 may be formed on the front substrate 20 to cover the sustain and scan electrodes 31 and 32. In addition, the second dielectric layer 23 may protect the sustain and scan electrodes 31 and 32 during gas discharging. The second dielectric layer 23 may be formed of a transparent dielectric material, e.g., a mixture of PbO—B₂O₃—SiO₂ having a high electrical conductivity.

The protective layer 24 may be formed on the second dielectric layer 23 to cover and protect the second dielectric layer 23. In addition, the protective layer 24 may increase secondary electron emission coefficient. The protective layer 24 may be formed of a transparent material, e.g., a magnesium oxide (MgO).

The sustain electrodes 31 may function as electrodes that apply a sustain pulse required for sustain discharge. The scan electrodes 32 may function as electrodes that apply a reset pulse and a scan pulse. The address electrodes 11 may function as electrodes that apply an address pulse. In operation, a reset discharge may occur via the reset pulse applied to the scan electrodes 32 for a reset period. For an address period, following the reset period, an address discharge may take place via the scan pulse applied to the scan electrodes 32 and via the address pulse supplied to the address electrodes 11. For a sustain period, the sustain discharge may occur via the sustain pulse applied to the sustain and scan electrodes 31 and 32. The functions of the sustain and scan electrodes 31 and 32 and address electrode 11 may further be varied in accordance to a voltage waveform applied to each discharge electrodes.

The barrier rib 16 may include a wide width portion 16W formed to have a first width W1 at a side of the rear substrate 10 and a narrow width portion 16N formed to have a second width W2 at a side of the front substrate 20 (as shown in FIG. 2). The first width W1 may be larger than the second width W2, i.e., the barrier rib 16 may be sloped extending from the wide width portion 16W to the narrow width portion 16N. The photoluminescent layer 19 may be formed on the inner surface of the barrier rib 16, i.e., on the sloped surface of the barrier rib 16.

The bus electrodes 31b and 32b may be formed on the front substrate 20 corresponding to the barrier rib 16 and may have a third width W3. The third width W3 may be smaller than the first width W1 and larger than the second width W2, i.e., the width W3 of the bus electrodes 31b and 32b may be larger than the narrow width portion 16N of the barrier rib 16.

Further, the bus electrodes 31b and 32b may be arranged to correspond with the narrow width portion 16N of the barrier rib 16, so that both ends of the bus electrodes 31b and 32b (in the y-axis direction) may correspond to the slope of the barrier rib 16. Since the bus electrodes 31b and 32b correspond with the narrow width portion 16N of the barrier rib 16 and the width W3 is larger than second width W2, a low reflection luminance may be maintained. Further, the width W3 of the bus electrodes 31b and 32b may be smaller than the first width W1 of the wide width portion 16W, so that interruption of emitted visible light from the discharge cells 17 may be minimized, i.e., prevent and/or reduce the luminance from deteriorating.

Table 1 illustrates a relationship between a reflection luminance and a luminance according to the first and second widths W1 and W2 of the barrier rib 16 and the third width W3 of the bus electrodes 31b and 32b.

TABLE 1
Reflection Luminance and Luminance according to Width of the Barrier
Ribs and Width of the Bus Electrode

| | | | Second | | | | |
|---|---|---|---|---|---|---|---|
| | Second | First | width/ | Third | Reflection | | |
| | width | width | First | width | luminance | Luminance | |
| | (μm) | (μm) | width | (μm) | (cd/m²) | (cd/m²) | Result |
| Example | 35 | 160 | 0.21 | 35 | 10.2 | 178 | High |
| Embodiment 1 | | | | 70 | 9.1 | 174 | Luminance |
| Example | 35 | 120 | 0.29 | 35 | 10.4 | 176 | maintained |
| Embodiment 2 | | | | 70 | 9.3 | 172 | |
| Example | 35 | 100 | 0.35 | 35 | 10.4 | 176 | |
| Embodiment 3 | | | | 70 | 9.1 | 173 | |
| Example | 40 | 160 | 0.25 | 40 | 10.2 | 177 | |
| Embodiment 4 | | | | 80 | 9.5 | 174 | |
| Example | 40 | 120 | 0.33 | 40 | 10.1 | 173 | |
| Embodiment 5 | | | | 80 | 9.4 | 172 | |
| Example | 40 | 100 | 0.4 | 40 | 10.6 | 173 | |
| Embodiment 6 | | | | 80 | 9.6 | 171 | |
| Example | 45 | 160 | 0.28 | 45 | 10.1 | 174 | |
| Embodiment 7 | | | | 90 | 9.2 | 172 | |
| Example | 45 | 120 | 0.37 | 45 | 10.3 | 172 | |
| Embodiment 8 | | | | 90 | 9.4 | 173 | |
| Comparative | 45 | 100 | 0.45 | 45 | 10.3 | 154 | Low |
| Example 1 | | | | 90 | 9.5 | 151 | Luminance |
| Comparative | 45 | 90 | 0.5 | 45 | 10.2 | 155 | maintained |
| Example 2 | | | | 90 | 9.6 | 150 | |
| Comparative | 45 | 80 | 0.56 | 45 | 10.4 | 150 | |
| Example 3 | | | | 90 | 9.5 | 149 | |

As shown in Table 1, ratios of the second width W2 and the first width W1 (W2/W1) may be approximately 0.20 to 0.45. A lower ratio W2/W1 value may indicate a lesser sloped surface of the barrier rib 16, i.e., closer to perpendicular, which may increase the amount of visible light emitted forward from the photoluminescent layer 19 formed on the slope of the barrier rib 16.

In example embodiments, the first width W1 of the wide width portion 16W may be approximately 100 μm to 160 μm and the second width W2 of the narrow width portion 16N may be approximately 35 μm to 45 μm. In another example embodiment, the first width W1 of the wide width portion 16W may be approximately 100 μm to 120 μm and the second width W2 of the narrow width portion 16N may be approximately 35 μm to 40 μm. In yet another example embodiment, the first width W1 of the wide width portion 16W may be 120 μm to 160 μm and the second width W2 of the narrow width portion 16N may be approximately 40 μm to 45 μm. The third width W3 of the bus electrodes 31b and 32b may be wider than the second width W2, e.g., approximately one to two times wider than the second width W2.

In addition, Table 1 illustrates that the Example embodiments (1-8) have reflection luminance values of approximately 9.1-10.6 candela per square meter (cd/m²) and luminance values of approximately 171-178 cd/m² (as compared to luminance values of approximately 149-155 cd/m² of the Comparative examples). Thus, Example embodiments (1-8) indicate a high luminance level while maintaining a low reflection luminance, as compared to Comparative embodiments (1-3), indicating a low luminance level while maintaining a low reflection luminance.

Other sizes of the wide width portion 16W and narrow width portion 16N of the barrier rib 16 may be employed to determine the reflection luminance and the luminance. In addition, the structure of the discharge cells 17 are not limited as described herein and other structure of the discharge cells 17 may be measured to obtain the reflection luminance and the luminance levels.

Referring again to FIG. 3, the barrier rib 16 may include first barrier rib members 16a extending in the first direction (i.e., y-axis direction) and second barrier rib members 16b between the first barrier rib members 16a extending in the second direction (i.e., x-axis direction), so that each discharge cell 17 may be an independent structure. The barrier ribs 16 defining the discharge cells 17 may be generally rectangular in shape. Other suitable geometrical shapes, e.g., polygons, circles, or ovals, may be used to define the discharge cells 17.

The bus electrodes 31b and 32b may cross the first barrier rib member 16a, and may be formed parallel with the second barrier rib member 16b corresponding to a third barrier rib member 116b and a fourth barrier rib member 216b. The third barrier rib member 116b and the fourth barrier rib member 216b may be formed as a double structure, i.e., the third barrier rib member 116b and the fourth barrier rib member 216b may be connected in a substantially parallel manner to form the second barrier rib members 16b. Further, the bus electrodes 31b and 32b may be disposed in parallel with two adjacent discharge cells 17, i.e., the bus electrodes 31b and 32b may be disposed at the front substrate 20 to correspond to each third barrier rib member 116b and fourth barrier rib member 216b.

The second barrier rib member 16b may further include a bridge barrier rib 316. The bridge barrier rib 316 may be disposed between the third barrier rib member 116b and the fourth barrier rib member 216b and may connect the third barrier rib member 116b and the fourth barrier rib member 216b in the first direction (i.e., y-axis direction).

The second barrier rib member 16b may further form an exhaust path 18 between the discharge cells 17 adjacent in the first direction (i.e., y-axis direction). The exhaust path 18 may be formed at the discharge cells 17 by the third barrier rib member 116b and the fourth barrier rib member 216b. The exhaust path 18 may exhaust remaining gas after sealing the rear and front substrates 10 and 20, and may provide a gas flow path when the discharge gas is filled in the PDP fabricating process. Accordingly, the exhaust path 18 may improve the exhaust performance.

Since the second barrier rib member 16b includes the third barrier rib member 116b and the fourth barrier rib member 216b, the bus electrodes 31b and 32b may be formed with a wider third width W3. The wider third width W3 may enlarge the aperture ratio of the discharge cells 17. Further, the exhaust path 18 formed in the second barrier rib member 16b may allow the bus electrodes 31b and 32b to have the wider third width W3, so as to maintain a low reflection luminance and improve luminance of light.

Example embodiments may provide a PDP having a barrier rib formed with a wide width portion 16W at a first substrate side and a narrow width portion 16N at a second substrate side. Further, bus electrodes may be formed on the second substrate corresponding to the barrier rib, so that a width W3 may be smaller than the wide width portion 16W and wider than the narrow width portion 16N.

Accordingly, the exemplary PDP 1 may maintain a lower reflection luminance and reduce the luminance from being deteriorated. Further, because a ratio (W2/W1) of the wide width portion 16W to the narrow width portion 16N may be approximately 0.20-0.45, high luminance may be maintained at approximately 171-178 cd/m², while maintaining a low reflection luminance at approximately 9.2-10.4 cd/m².

In the figures, the dimensions of layers, regions and elements may be exaggerated for clarity of illustration. It will also be understood that when a layer, region and element is referred to as being “on” or “connected to” another layer, region and element, it can be directly on or connected to the other layers, regions and elements or intervening layers, regions and elements may be present. In contrast, when a layer, region or element is referred to as being “directly on” or “directly connected to” another layer, region or element, there are no intervening layers, regions and elements present. Further, it will be understood that when a layer, region and element is referred to as being “under” or “above” another layer, it can be directly under or directly above, and one or more intervening layers, regions and elements may also be present. In addition, it will also be understood that when a layer, region and element is referred to as being “between” two layers, it can be the only layer, region and element between the two layers, regions and elements, or one or more intervening layers, regions and elements may also be present. Like numbers refer to like elements throughout. As used herein, the term “and/or” includes any and all combinations of one or more of the associated listed items.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the example embodiments as set fourth in the following claims.

What is claimed is:

1. A plasma display panel (PDP), comprising:
a first substrate and a second substrate positioned to face each other;
a barrier rib arranged between the first and second substrates to define a discharge cell;
a photoluminescent layer formed in the discharge cell; and
discharge electrodes including address electrodes and display electrodes, the address electrodes extending along a first direction and the display electrodes extending along a second direction intersecting the first direction, wherein:
the display electrodes include a first electrode and a second electrode extending in the second direction, the first and second electrodes correspond to the barrier rib, and
the barrier rib includes a wide width portion having a first width W1 formed at a side of the first substrate and a narrow width portion having a second width W2 formed at a side of the second substrate, the second width W2 being narrower than the first width W1.

2. The PDP as claimed in claim 1, wherein the first and second electrodes are bus electrodes.

3. The PDP as claimed in claim 2, wherein a width (W3) of the bus electrodes is narrower than the first width W1 and wider than the second width W2.

4. The PDP as claimed in claim 3, wherein a ratio of the second width to the first width (W2/W1) is approximately 0.20 to 0.45.

5. The PDP as claimed in claim 4, wherein the first width W1 is approximately 100 μm to 160 μm and the second width W2 is approximately 35 μm to 45 μm.

6. The PDP as claimed in claim 5, wherein the first width W1 is approximately 100 μm to 120 μm and the second width W2 is approximately 35 μm to 40 μm.

7. The PDP as claimed in claim 5, wherein the first width W1 is approximately 120 μm to 160 μm and the second width W2 is approximately 40 μm to 45 μm.

8. The PDP as claimed in claim 5, wherein the third width W3 of the bus electrodes is approximately one to two times wider than the second width W2.

9. The PDP as claimed in claim 1, wherein a surface of the barrier rib is sloped extending from the wide width portion of the barrier rib to the narrow width portion of the barrier rib.

10. The PDP as claimed in claim 2, wherein the barrier rib further comprises:
first barrier rib members extending in the first direction and formed at the discharge cell interval along the second direction; and
second barrier rib members extending in the second direction between the first barrier rib members and formed at the discharge cell interval along the first direction.

11. The PDP as claimed in claim 10, wherein the bus electrodes are formed on the second substrate corresponding to the second barrier rib members.

12. The PDP as claimed in claim 10, wherein the second barrier rib members include a third barrier rib member and a fourth barrier rib member.

13. The PDP as claimed in claim 12, wherein the third barrier rib member and the fourth barrier rib member are separated between consecutive discharge cells in the first direction to form an exhaust path.

14. The PDP as claimed in claim 13, further comprising a bridge barrier rib connecting the third barrier rib member and the fourth barrier rib member.

15. The PDP as claimed in claim 14, wherein the bridge barrier rib is disposed between the third barrier rib member and the fourth barrier rib member in the first direction.

16. The PDP as claimed in claim 12, wherein the bus electrodes are formed on the second substrate corresponding to the third barrier rib member and the fourth barrier rib member.
